(19) United States
(12) Patent Application Publication
(10) Pub. No.: US 2008/0180941 A1
(43) Pub. Date: Jul. 31, 2008

(54) Luminous textile

(76) Inventor: Wei-Jei Tuan, Taipei (TW)

Correspondence Address: Tuan Wei-Jei, P.O.Box 166-13, Taipei, 115, omitted

(21) Appl. No.: 12/003,405

(22) Filed: Dec. 26, 2007

Related U.S. Application Data
(63) Continuation-in-part of application No. 11/657,627, filed on Jan. 25, 2007.

(51) Int. Cl. F21V 21/00; F21V 9/16

(52) U.S. Cl. 362/103; 362/84

(57) ABSTRACT

The present invention is related to a luminous textile comprising a luminous lamp coupled to a pad, which is further coupled to the textile. The luminous lamp includes a light emission electric circuit, a battery, a pressure sensitive switch, and a plastics. The light emission electric circuit includes a first printed circuit board (PCB), a control integrated circuit (IC), and a plurality of light emitting diodes (LEDs); the light emission electric circuit is electrically connected to the battery as a power supply to conduct electricity, the pressure sensitive switch is electrically connected to the first PCB, said light emission electric circuit, battery and pressure sensitive switch is enclosed by the plastics pervious to light. When the pressure sensitive switch is vibrated, each of LEDs activated to emit light one by one in sequence.

The present invention is continuation in part of U.S. application Ser. No. 11/657,627 filed on Jan. 25, 2007.

### FIELD OF THE INVENTION

The invention is to provide a luminous lamp; particularly applied to a textile activated by vibrations to emit light.

### BACKGROUND OF THE INVENTION

Nowadays, material standard of living is already defined as a “well clad and well fed” life style. When wearing, not only keeps warmth about a wearer's body, but also amuses one's companions. Therefore, either put on clothing or shoes, wearers are likely moved by ideas such as update your styles—and get tied to the cause, value added accessory showing off together with peers is sought.

In accompaniment with advanced technology, a lot of electronics are applicable to luminous objects. On the market, integrated circuit (IC) coupled with light emitting diodes (LEDs) is already applied to shoes, packs etc. Especially when wearers walk on the side walk with shoes emitting light to please the eye, as far as eye can see, most of onlookers are aware of the light emission.

However, artificial selection means anything familiar to us is gradually come to eye sore. Light emission from either shoes or packs is not forever new and fresh, or welcome by everyone. Advance technology makes LEDs triggered by pressure sensitive switch etc., applicable to kinds of shoes or packs. Besides, most of such LEDs are electrified by swaying spring, which may be swayed insufficiently and out of contact with LEDs to cause dim light.

### SUMMARY OF THE INVENTION

Accordingly, the present invention is to provide a luminous textile with interesting and glittering effect to meet people's needs, also with pressure sensitive mechanism to emit light without wasting power for unexpected light emissions.

The luminous textile comprising: a textile, a pad coupled to a surface of the textile, and, at least, a lamp enclosed inside the pad; the lamp includes a light emission electric circuit consists of a first printed circuit board (PCB) with a control integrated circuit (IC), and a plurality of light emitting diodes (LEDs); said control IC and LEDs are electrically connected to the first PCB; at least, a battery electrically connected to the light emission electric circuit; a pressure sensitive switch includes a second PCB, an insulated housing, and, at least, a metal rolling ball; said second PCB is electrically connected to said first PCB; said second PCB is provided with a plurality of first, second conduction portions; said insulated housing is coupled to said second PCB, said first, second conduction portions are received inside the insulated housing; the metal rolling ball is also rotatably received inside the insulated housing; and a transparent plastics encloses said light emission electric circuit, battery and pressure sensitive switch.

As a result, when said pressure sensitive switch is vibrated, said metal rolling ball is in contact with any of the first, second conduction portions to output a trigger signal, said control IC receives the trigger signal further outputs a drive signal to light said LEDs through a preset light emission duration.

### BRIEF DESCRIPTION OF THE DRAWINGS

FIG. 1: an exploded view of the luminous lamp.

FIG. 2: a schematic view of the luminous lamp assembled in part.

FIG. 3: a schematic view of the luminous lamp assembled as a whole.

FIG. 4: a diagrammatic view of wiring diagram of the luminous lamp.

FIG. 5: a diagrammatic view of block diagram of the luminous lamp.

FIG. 6: a schematic view of the luminous lamp coupled to the textile.

FIG. 7: a sectional view of the luminous lamp and the pad.

FIG. 8: a cross sectional view of the luminous lamp coupled to the pad and the textile.

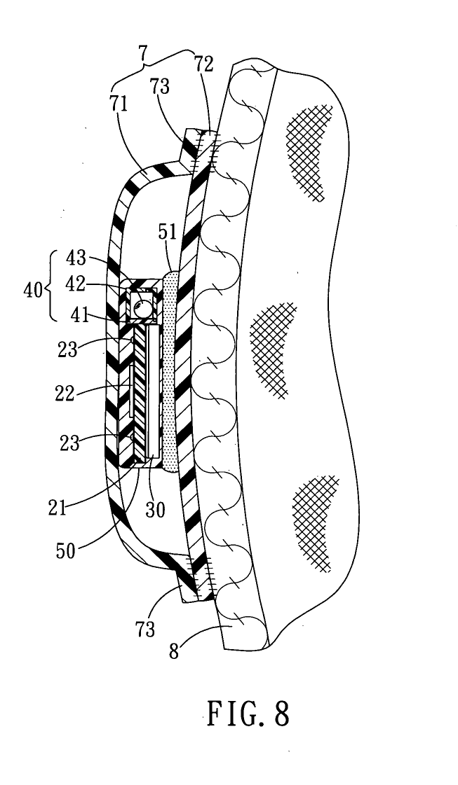

FIG. 9: a sectional view of the inflated pad of FIG. 8.

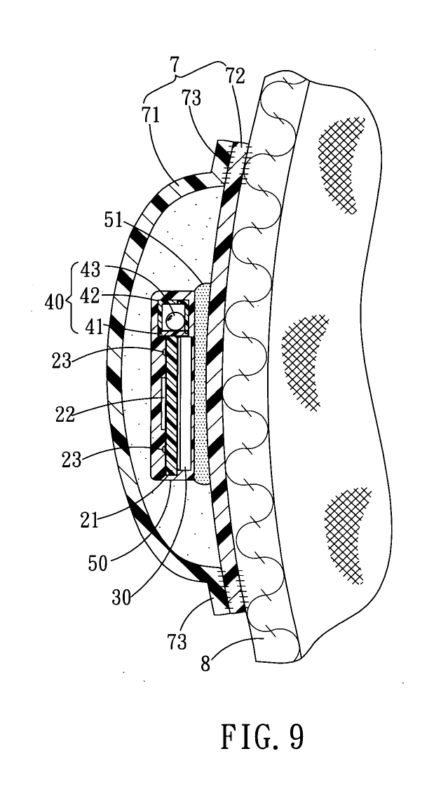

### DETAILED DESCRIPTION OF THE PREFERRED EMBODIMENTS OF THE INVENTION

The present invention is described in detail according to the appended drawings hereinafter.

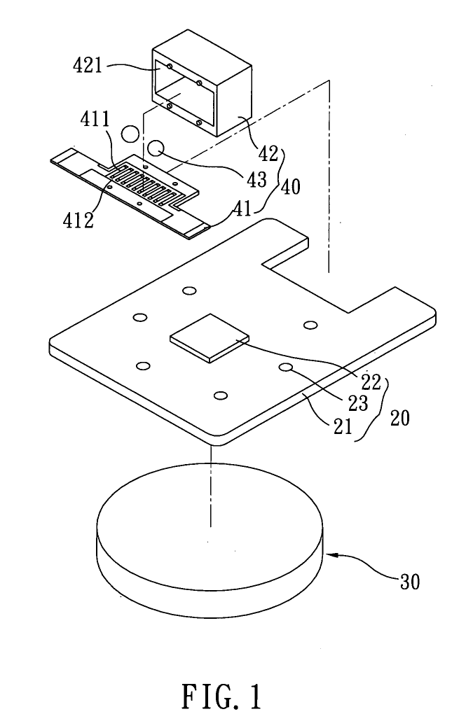

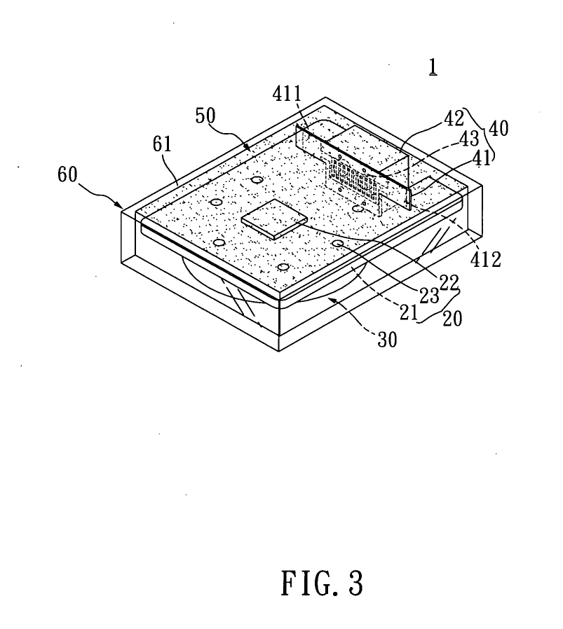

As shown in FIG. 1˜FIG. 3, the luminous lamp (1) includes a light emission electric circuit (20), at least, a battery (30); a pressure sensitive switch (40), a plastics (50) and an insulated housing (60).

Said light emission electric circuit (20) includes a first printed circuit board (PCB) (21), a control integrated circuit (IC) (22), and a plurality of light emission diodes (LEDs) (23). Said first PCB is approximately square in shape, a first surface on the first PCB is configured with an electric circuit. (not shown) While the control IC (22) is disposed to the first surface of the first PCB further electrically connected to the electric circuit on the first PCB. Each of the LEDs (23) is installed on the first surface of the first PCB (21) and electrically connected to the electric circuit of the first PCB (21). In the drawings, six LEDs (23) installed on the PCB (21) is exemplified. However, more LEDs can be added to the PCB (21) to meet user's requirements.

Each of the LEDs (23) is selected from a full color LED, bicolor LED, and mono color LED or in combination with color LEDs as mentioned above. Further, full color LED is composed of different color flip LED chips (such as red, green, blue tricolor) (not shown). LED chips are directly installed on the first PCB (21) to show combinations of color light. Said mono color LED (23) is composed of a single color LED chip (such as yellow color LED) directly installed on the first PCB (21) to show color light of a single color.

Said battery (30) is selected from a lithium battery or nickel cadmium (Ni Cd) battery etc., which is electrically connected to a second surface of the PCB (21). One battery is exemplified in the drawings; however, more batteries can be added to the first PCB to meet user's requirements.

Said pressure sensitive switch (40) includes a second PCB (41), an insulated housing (42), and, at least, a metal rolling ball (43). Size of the second PCB (41) is dimensioned smaller than the first PCB (21). On the second PCB (41), a plurality of first conduction portions (411) assigned as cathodes are opposite to a plurality of second conduction portions (412) assigned as cathodes respectively. The first, second conduction portions (411, 412) are relative to each other in pairs. The first, second conduction portions (411, 412) are arranged in horizontal alignment with each other, each of the first conduction portion (411) is interleave with each of the second conduction portion (412), and in opposite to each other respectively.

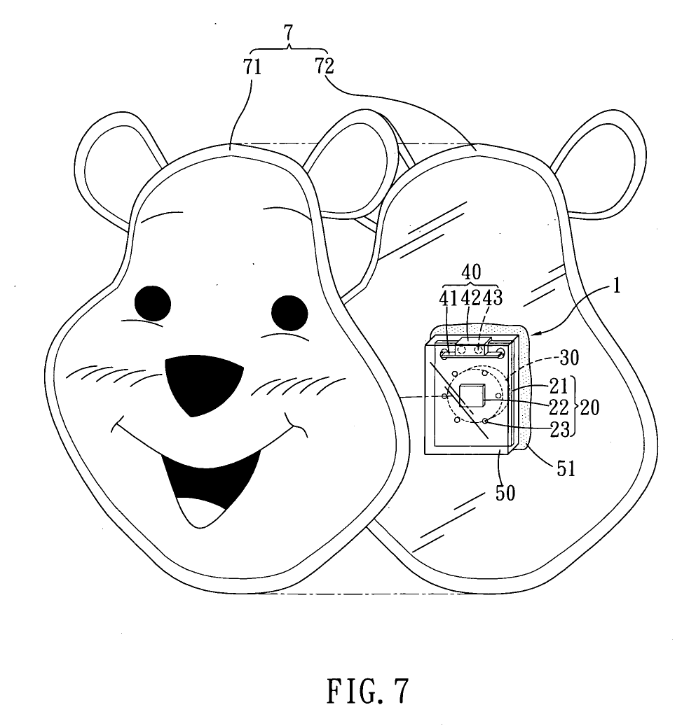

Said insulated housing (42) is made from electrically insulated materials, such as rubber, or plastics. The insulated housing (42) is approximately square in shape but pervious to light. The insulated housing (42) is concave in shape to form a cavity (421) caved inward from a side surface. (in FIG. 1, it is exemplified caved downward from an upper surface) Said metal rolling ball (43) is made of copper or the like with electricity conductivity. One or two metal rolling balls (43) are rotatably received inside the cavity (421); however, in the present invention, there are two balls (43) exemplified in FIGS. 1 and 7.

As shown in FIGS. 1˜2, said metal rolling balls (43) are first received inside the cavity (421); and then, a first surface of the second PCB (41) is enclosed inside the insulated housing (42) by adhesion or by coupling engagement. Meanwhile, the first, second conduction portions (411, 412) are received inside the cavity (421) of the insulated housing (42). Finally, the second PCB (41) is coupled to the first PCB (21), where the first, second conduction portions (411, 412) are electrically connected to the electric circuit on the first surface of the first PCB (21). In other words, the cavity (421) of the insulated housing (42) is substantially sealed by the first PCB (21), the first surface of the first PCB formed with the electric circuit, the first, second conduction portions, and, at least, one metal rolling ball are all enclosed inside the cavity.

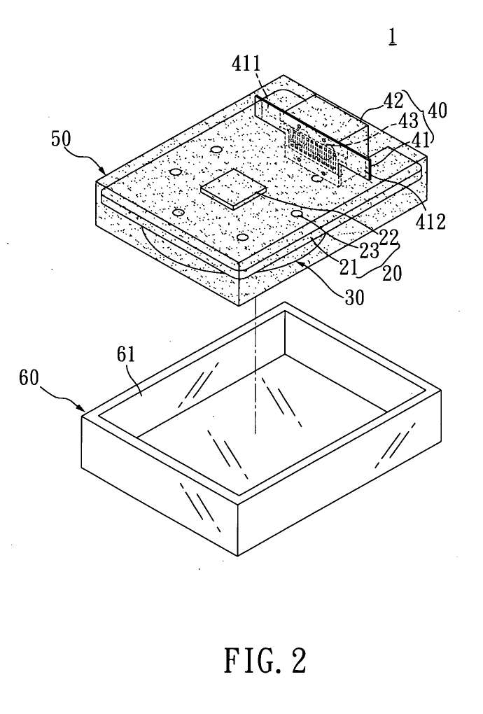

As shown in FIG. 2, said plastics (50) made from plastic pervious to light by injection molding. Said light emission electric circuit (20), said battery (30), and said pressure sensitive switch (40) are enclosed inside the plastics (50), which is further pervious to light. LEDs (23) can emit light through the plastics (50).

As shown in FIGS. 2 and 3, the insulated housing (60) is made from plastic pervious to light. The insulated housing (60) is concaved downward from an upper surface to form a cavity (61). The cavity (61) is designed to receive said plastics (50), said light emission electric circuit (20), said battery (30), and said pressure sensitive switch (40). Or the light emission electric circuit (20), the battery (30), and the pressure sensitive switch (40) are first received inside the cavity (61), and then the plastics (50) pervious to light is coupled inside the cavity (61) by sealing to enclose the light emission electric circuit (20), the battery (30), and the pressure sensitive switch (40) inside the plastics (50). Moisture permeation or intrusion to the light emission electric circuit (20) is therefore prevented from happening.

Next, when the luminous lamp (1) is vibrated by an outer force, the metal rolling balls (43) are rotated or rolled to contact any of the first, second conduction portions (411, 421), where the pressure sensitive switch (40) conducts electricity to the electric circuit of the first PCB (21), further the LEDs (23) are activated to light up.

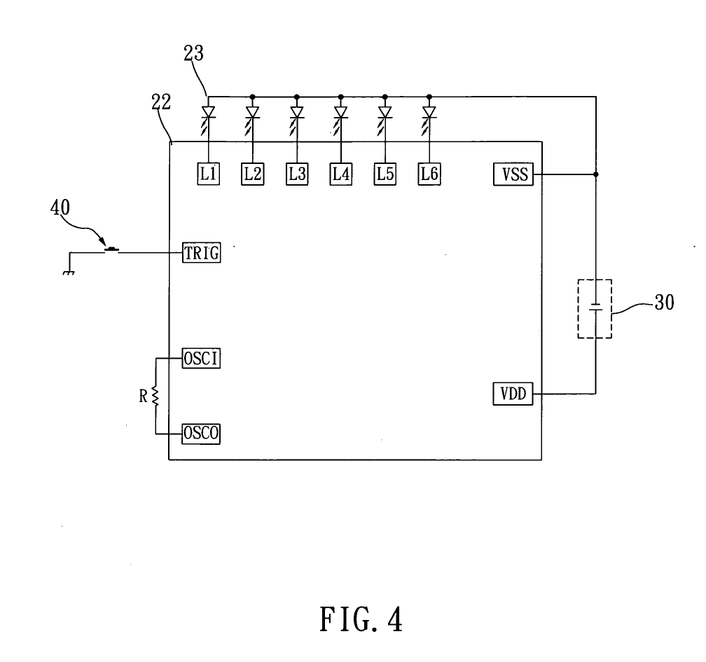

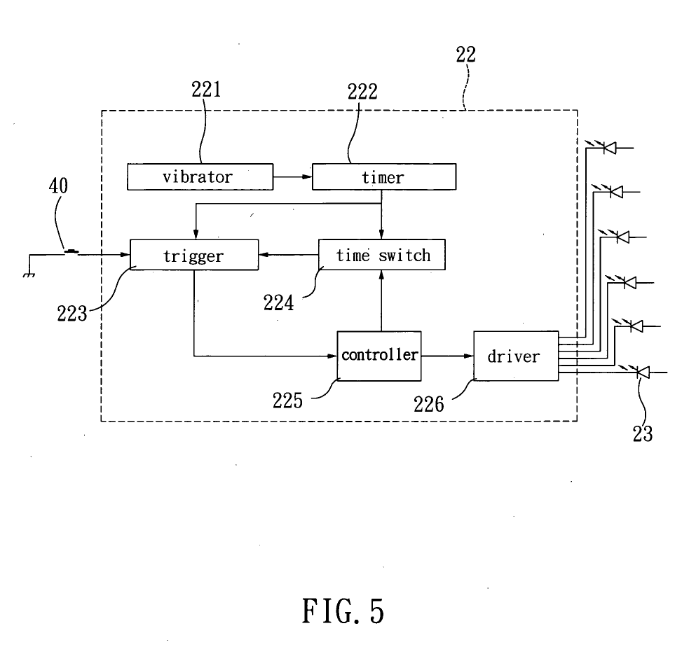

As shown in FIGS. 4 and 5, said control IC (22) is electrically connected to a pressure sensitive resistor (R) through the electric circuit, each of the LEDs (23), the battery (30), and the pressure sensitive switch (40). The control IC (22) includes a vibrator (221), a timer (222), a trigger (223), a logic gate like time switch (224), a controller (225), and a driver (226).

Said vibrator (221), and timer (222) output working frequency to the trigger (223) and time switch (224). The trigger (223) is electrically connected to the pressure sensitive switch (40), which is vibrated to output a trigger signal to the controller (225). After the control IC (22) receives the trigger signal, the time switch (224) determines whether the control IC (22) continues to output a drive signal to the LEDs (23) within a preset light emission duration. At the same duration, to avoid any confusion in the continuous use of the trigger signal, the controller (225) causes one short circuit when a conflict or following trigger signal is appeared. Otherwise, the LEDs (23) emit light through the light emission duration due to following trigger signals continue to trigger the LEDs (23). Said driver (226) receives the drive signal of the controller (225) of the control IC (22) electrifies each of the LEDs (23) to emit light.

As above, the trigger (223) outputs trigger signals to the controller (225) when the pressure sensitive switch (40) is vibrated. At the same time, LEDs (23) emit light in sequence or at random according to the vibrations within the light emission duration related to the time switch (224), by which the LEDs lit up one by one in sequence is processed. Moreover, light emission of LEDs (23) substantially activated by the metal rolling ball (43) in contact with the conduction portions (411, 421) of the second PCB (41). Since the metal rolling ball (43) ensures conductor quality by rolling in continuation to contact with conduction portions (411, 421); so the pressure sensitive switch (40) can conduct electricity promptly to prevent dim light of the LEDs (23) caused by insufficient vibrations.

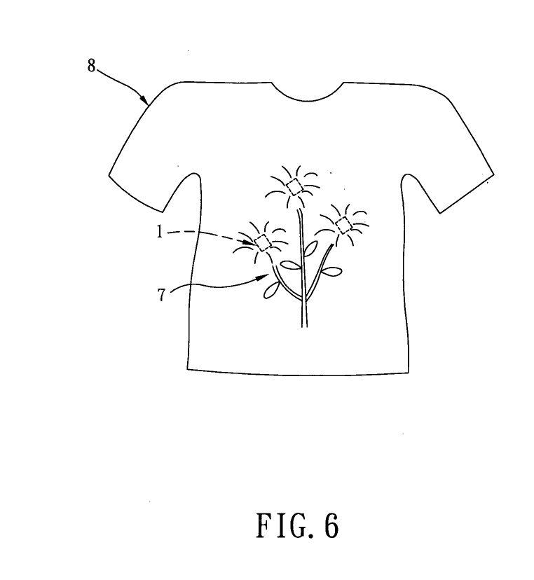

As shown in FIG. 6, the luminous lamp (1) is coupled to a pad (7); in turn, the pad (7) is further coupled to a textile (8). At least, one luminous lamp (1) is incorporated to the pad (7). The pad (7) can be shaped as cartoon icons, pets figure, fictional characters, or patterns. The textile (7) can be formed as clothing, stocking, pack or hat. In the present invention, the textile is exemplified by clothing, the pad: by patterns.

Pad (7) can be shaped as an emblem made from polyvinyl chloride (PVC) as one luminous lamp (1) sandwiched between a front and a back pieces of PVC by heat press. Thereby, the luminous lamp (1) is coupled with the emblem, which is further incorporated to a surface of the textile (8) facing outward.

Or, the pad (7) made from plastics, which is hollow inside for receiving the luminous lamp (1). Then the plastics can be stitched to the surface of the textile by stitching.

As a result, as a wearer puts on the textile (8) that emits light due to the wearer is taking a walk to vibrate the pressure sensitive switch (40). LEDs (23) emit light in order in response to the vibrations. The pad (7) made from PVC or plastics is aimed to provide a waterproof function to the luminous lamp (1), which is therefore exempted from moisture intrusion or permeation to cause dim light.

As shown in FIG. 7, said pad (7) is composed of a first waterproof sheet (72) pervious to light as a base, and a second waterproof sheet (71) pervious to light and printed with patterns as a cover. Rims of the first, second sheets (71, 72) are sealed together by high frequency waves to form a hollow cavity in between. The cavity is used to receive said luminous lamp (1), which is further fixed to a widened middle portion inside the pad (7). The sealed rims (73) of the sheets (71, 72) further coupled to the textile (8) by stitching or high frequency waves.

Said pad (7) can be inflated and filled with air or helium to avoid the second sheet (72) from folding into ridges, further the inflated pad is shaped likely a bumper to absorb shock and prevent serious damages happened to the luminous lamp (1). Air or helium is defined to occupy 30˜70% space inside the pad (7). Once air or helium occupied space less than 30%, the second sheet (72) is easy to fold into ridges. Or when air or helium occupied space more than 70%, the pad (7) full with air or helium may cause damages when impinged seriously.

Said first, second sheets (71, 72) can be also made from translucent clothes. Rims of the first, second sheets (71, 72) are sealed together by adhesive or stitching to form a cavity in between for receiving the luminous lamp (1). Further, the pad (7) is stitched to the textile (8) by stitching. The luminous lamp (1) is fixed to a widened middle portion inside the pad (7). A surface of the second sheet (72) can be printed with patterns, or patterns formed by electric embroidering.

Said luminous lamp (1) can be securely adhered to the second sheet (72) by an adhesive (51) or ultra sonic waves. As a result, the luminous lamp (1) is fixed to a widened middle portion inside the pad (7) without any movements to emit light evenly to surrounding objects.

What is claimed is:

1. A luminous textile comprising:
a textile;
a pad coupled to a surface of the textile; and
at least, a luminous lamp coupled to the pad; the luminous lamp includes:
a light emission electric circuit consists of a first printed circuit board (PCB) with a control integrated circuit (IC), and a plurality of light emitting diodes (LEDs); said control IC and LEDs are electrically connected to the first PCB;
at least, a battery electrically connected to the light emission electric circuit;
a pressure sensitive switch includes a second PCB, an insulated housing, and, at least, a metal rolling ball; said second PCB is electrically connected to said first PCB; said second PCB is formed with a plurality of first, second conduction portions; said insulated housing is coupled to said second PCB, said first, second conduction portions are received inside the insulated housing; the metal rolling ball is also rotatably received inside the insulated housing; a transparent plastics encloses said light emission electric circuit, battery and pressure sensitive switch; and
a plastics pervious to light encloses said light emission electric circuit, said battery, and said pressure sensitive switch;
said pressure sensitive switch is vibrated, said metal rolling ball is in contact with any of the first, second conduction portions to output a trigger signal to the control IC, a time switch of the control IC outputs a drive signal to light LEDs in a preset light emission duration.

2. The luminous textile of claim 1 wherein the textile is selected from one of the following: clothing, stocking, hat, and pack.

3. The luminous textile of claim 1 wherein the pad is an emblem.

4. The luminous textile of claim 1 wherein the pad is stitched to the textile.

5. The luminous textile of claim 1 wherein the control IC includes:
a trigger is electrically connected to the pressure sensitive switch to output a trigger signal;
a driver electrifies said LEDs to emit light;
a controller receives the trigger signal to output a drive signal to the driver to light up said LEDs in sequence; and
a time switch determines light emission durations of LEDs.

6. The luminous textile of claim 1 wherein said LED is selected from one of the following: full color LED, bicolor LED, mono color LED, or in combination of color LEDs as mentioned above.

7. The luminous textile of claim 1 wherein said first, second conduction portions are arranged in horizontal alignment with each other, each of the first conduction portion is interleave with each of the second conduction portion, and in opposite to each other respectively.

8. The luminous textile of claim 1 wherein said insulated housing pervious to light, and concaved inward from a side surface to form a cavity.

9. The luminous textile of claim 1 wherein the controller (225) causes one short circuit when a conflict or following trigger signal is appeared in the preset light emission duration.

10. The luminous textile of claim 1 wherein the luminous lamp further includes an insulated housing pervious to light, the insulated housing is concaved downward from an upper surface to form a cavity to receive said plastics, said light emission electric circuit, said battery, and said pressure sensitive switch.

11. The luminous textile of claim 1 wherein the pad is composed of a first waterproof sheet pervious to light as a base, and a second waterproof sheet pervious to light and printed with patterns as a cover; rims of the first, second sheets are sealed together by high frequency waves to form a hollow cavity in between, the cavity receives said luminous lamp, which is further fixed to a widened middle portion inside the pad; the sealed rims of the sheets further coupled to the textile.

12. The luminous textile of claim 11 wherein the pad is inflated and filled with air to avoid the second sheet from folding into ridges, and the inflated pad likely a bumper to absorb shock.

13. The luminous textile of claim 12 wherein air is defined to occupy 30˜70% space inside the pad.

14. The luminous textile of claim 1 wherein said first, second sheets made from translucent clothes, rims of the first, second sheets sealed together to form a cavity in between for receiving the light emission electric circuit, battery, pressure sensitive switch enclosed inside the plastics, which is pervious to light and fixed to a widened middle portion inside the pad; sealed rims of the pad is further coupled to the textile.

15. The luminous textile of claim 11 wherein the plastics is adhered to the first sheet by adhesive.

16. The luminous textile of claim 11 wherein the plastics is adhered to the first sheet by high frequency waves.

17. The luminous textile of claim 11 wherein the sealed rims of the pad is fixed to the textile by high frequency waves.

18. The luminous textile of claim 11 wherein the sealed rims the pad is fixed to the textile by stitching.

19. The luminous textile of claim 11 wherein the second sheet is printed with patterns.

20. The luminous textile of claim 11 wherein patterns of the second sheet is formed by electric embroidering.
